(19) United States
(12) Patent Application Publication
(10) Pub. No.: US 2003/0201899 A1
(43) Pub. Date: Oct. 30, 2003

(54) Signaling fire detector

(76) Inventors: Joachim Schneider, Unterhaching (DE); Anton Pfefferseder, Sauerlach-Arget (DE); Andreas Hensel, Vaihingen (DE); Ulrich Oppelt, Zorneding (DE)

Correspondence Address: KENYON & KENYON, ONE BROADWAY, NEW YORK, NY, 10004, US

(21) Appl. No.: 09/555,691

(22) PCT Filed: Oct. 1, 1999
(86) PCT No.: PCT/DE99/03156

(30) Foreign Application Priority Data
Oct. 2, 1998 (DE) 198 45 553.4

(51) Int. Cl. G08B 17/10

(52) U.S. Cl. 340/632; 340/628; 340/577

(57) ABSTRACT

The present invention relates to a fire detector having a sensor group (10), which contains at least one conventional fire detection sensor (12, 13); and having a control and evaluation unit (9), which is connected to the sensor group (10), set up to evaluate the signal (S2, S3) supplied by the at least one fire detection sensor, and if necessary, set up to output at least one control signal (T1; T2) for the fire detection sensor(s) (12, 13); the fire detector being characterized in that the sensor group (10) also has a chemosensor (11) or a chemosensor array, which is likewise connected to the control and evaluation unit (9) for evaluating the detection signal (S1) of the chemosensor or chemosensor array, and which is set up on the basis of a chemical sensor-operation principle to detect gas and/or smoke emissions created by fire. The additional chemosensor is preferredly an optoelectronic gas sensor functioning on an optode basis, or an optoelectronic gas sensor array functioning on an optode basis.

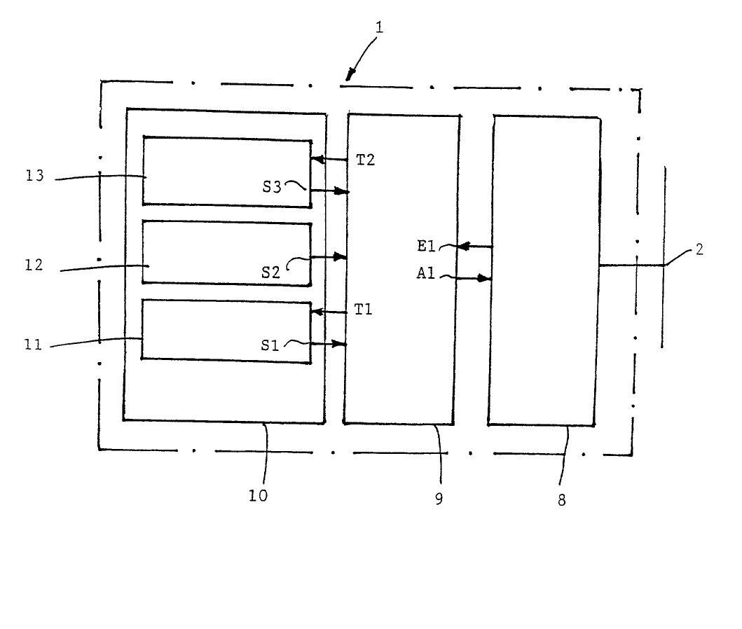

### BACKGROUND INFORMATION

The present invention relates to a fire detector having a sensor group, which includes at least one conventional fire detection sensor; and having a control and evaluation device, which is connected to the sensor group, set up to evaluate the signal supplied by the at least one fire detection sensor, and if necessary, set up to output at least one control signal for the fire detection sensor(s).

In every fire, the burning substances undergo a material and energetic conversion. In this case, soot particles, aerosols, and gases are formed in addition to the ash remaining at the center of the fire. Based on the various physical processes in the air, such as thermal diffusion and turbulences, smoke particles are formed, which are detected by the fire detectors, optical smoke detectors, and ionization detectors used today.

The response characteristics of the optical smoke detectors and ionization detectors are a function of the type of fire. They are not equally sensitive in all types of fires. In this context, the amount and the composition of the produced smoke play a role as influence variables (quantities). Thus, fires generating a small amount of smoke are naturally not detected as well as fires producing a large amount of smoke. In addition, the scattered-light smoke detector is dependent on the light being reflected from the smoke particles. This results in the response characteristics of optical smoke detectors being nonuniform in various types of fires.

The energy released in the fire leads to an increase in temperature and an emission of radiation by the flames, which is detected by heat detectors (temperature detectors) and flame detectors.

The reliability of today's fire detectors is high; however, single-sensor detectors react to illusory quantities in critical situations. Due to the large number of fire detectors used, the number of false alarms attributable to them and the accompanying responses by the fire department are not negligible. In certain application cases, conventional smoke detectors cannot be used, because either the ambient conditions are not suitable, or the fire intensity does not fall into the detection range of the detector.

The industry is attempting to solve a part of this problem by combining the known technologies. In order to render the response characteristics of fire detectors more uniform, optical smoke detectors are often combined with an ionization detector or a temperature detector. In the planning and design of a fire detection system, the combination can mean providing various types of fire detector in one space. However, if various detection principles are already integrated in one fire detector, then a wide spectrum of possible fires can be detected by a single type of detector. A known example of this is the combination of an optical smoke detector with a temperature sensor.

The gases formed during the burning of the combustible material are generally designated as combustion gases. In the starting phase of fires, CO, saturated and unsaturated hydrocarbons, alcohols, and acids are formed due to incomplete combustion. Organic materials burn as a rule, which is why CO, CO2, and H2O are the predominantly formed oxides. From approximately 200° C. on, NOx is formed in the fire from the oxygen and nitrogen in the air.

To this day, a detection system for the gases formed in a fire is yet to be used in conventional fire detection technology. Reference is made here to a technical article of Appleby, D. Ellwood, S. H.: “Volumetric fire detection using imaging of fire products and transport phenomena”, AUBE 1995.

### SUMMARY OF THE INVENTION

In view of what is said above, the object of the present invention is to expand the operative range (range of application) of a fire detector equipped with conventional fire detection sensors, to design its response characteristics to be more uniform, and to increase the reliability (signal-to-noise ratio) of the fire detector.

The fire detector achieving the above-mentioned object of the present invention is with a sensor group, which has at least one conventional fire detection sensor; and provided with a control and evaluation unit, which is connected to the sensor group, set up for evaluating the signal supplied by the at least one fire detection sensor, and if necessary, set up for outputting at least one control signal for the fire detection sensor(s); characterized in that the sensory group also has a chemosensor or a chemosensor array, which is likewise connected to the control and evaluation unit for evaluating the detection signal of the chemosensor or chemosensor array, and which is set up on the basis of a chemical sensor-operation principle to detect gas and/or smoke emissions caused by a fire.

This fire detector according to the present invention, which can either be equipped with a single conventional sensor that is a scattered-light sensor, ionization sensor, or a temperature sensor, or can alternatively combine two conventional sensors as well, e.g. a scattered-light sensor and a temperature sensor, preferably includes an optoelectronic gas sensor functioning on an optode basis as a chemosensor, or an optoelectronic gas sensor array functioning on an optode basis as a chemosensor.

Since, in addition to the temperature increasing, gaseous combustion products are also formed in a fire, these can improve the safety of fire detection, i.e. increase the signal-to-noise ratio and achieve a more rapid and more uniform fire-detection sensitivity, after being detected by the chemosensor or chemosensor array additionally provided in the present invention. Tests conducted by the inventor have shown that both accelerated response characteristics and an increased signal-to-noise ratio can be achieved by evaluating the additional signal(s) generated by a chemosensor or chemosensor array during a fire.

An optoelectronic gas sensor that functions on an optode basis using a chemical principle of sensor operation is the subject matter of DE 197 41 335.8 of Robert Bosch GmbH. With such a chemosensor, it is very simple to manufacture miniaturized gas sensors, i.e. the so-called optodes, by using an optode sensor membrane to determine a physical and/or chemical parameter of a sample substance whose light-absorption properties change, based on an indicator substance contained in the sample substance, in response to at least indirect contact with a gas and/or gas mixture to be measured.

In this case, a chemosensor membrane is preferably made of a gas-sensitive polymer carrier material, to which an indicator substance from the following group of compounds is added: azobenzenes, acetophenones, corrins, porphyrins, phthalocyanines, macrolides, porphyrinogens, nonactin, valinomycin, triphenylmethanes, diphenylmethanes, antracene, antrachinones, oxazoles, and/or complexes of these compounds with transition metals of the I-II and the IV-VIII subgroups.

Another earlier patent application of Robert Bosch GmbH relates to producing an optoelectronic gas sensor array, which functions on an optode basis and is in the form of a chip; and in which several photosensitive elements separated from each other, and a light transmitter centrally located among them, are integrated in or on a semiconductor substrate. The photosensitive elements are each covered by segments of the optode material, and by a segment of a reference material; the optode material being made of a gas-sensitive polymer carrier material to which a chromium ionophore (ion carrier) is added, and the reference material being made of a polymer carrier material without a chromium ion carrier.

The fire detector of the present invention, which uses a chemosensor as an additional detector in the fire detector, allows the fire to be detected earlier because of the higher diffusion rate of the gases formed in a fire, and allows an increase in the signal-to-noise ratio through the evaluation of the combustion gases, since at least one additional quantity detected by the chemosensor and evaluated by the control and evaluation unit is added to the quantities detected by the conventional sensors.

A preferred embodiment of a fire detector according to the present invention is described below in further detail, using the one FIGURE.

### DETAILED DESCRIPTION

The FIGURE shows a block diagram of a fire detector 1, which can be connected by a bus system 2 to a primary (master) system, in order to supply fire signals to this system and receive commands from this system. Sensor group 10 of fire detector 1 has a chemosensor or a chemosensor array 11, which is preferably an optoelectronic gas sensor functioning on an optode basis or an optoelectronic gas sensor array functioning on an optode basis, and which has two conventional sensors, e.g. a thermistor 12 and a scattered-light sensor 13 used as an optical smoke sensor.

Instead of two conventional fire detector sensors 12, 13, fire detector 1 can alternatively have only one conventional sensor, which is, e.g. a scattered-light sensor, an ionization sensor, or a temperature sensor.

Sensors 11, 12, 13 of sensory group 10 are in individual signal communication with a control and evaluation unit 9, which is set up to evaluate signals S1,S2, and S3 supplied by the respective fire detection sensor, and is set up to output control signals T1 and T2 for the fire detection sensor(s). Control and evaluation unit 9 includes a microprocessor and an analog-digital converter for converting signals S1-S3 supplied by the sensors into digital signals, and the control and evaluation unit is set up to evaluate these signals. Control and evaluation unit 9 is also connected to a bus interface 8, which includes bus-specific hardware for communicating via bus 2. The control and evaluation unit also outputs an evaluated fire detection signal A1, via bus interface 8 and bus 2, to a fire alarm receiving station not shown, and receives command and actuating signals E1 from this fire alarm receiving station via bus 2, e.g. for adjusting (setting) the sensor characteristics and adapting evaluating parameters. This renders fire detector 1 highly flexible.

Because described fire detector 1 according to the present invention includes a chemosensor or a chemosensor array 11 in addition to the conventional sensor(s), i.e. in addition to exemplarily described thermistor 12 and scattered-light sensor 13, and because control and evaluation unit 9 also evaluates the signals of the chemosensor or chemosensor array, a fire can be advantageously detected in a safe and timely manner through early detection of the gases formed during the course of the fire; and because of the additional chemosensor, the fire can be detected with a higher signal-to-noise ratio than that of conventional fire detectors.

1. A fire detector having a sensor group (10), which contains at least one conventional fire detection sensor (12, 13); and having a control and evaluation unit (9), which is connected to the sensor group (10), set up to evaluate the signal (S2, S3) of the at least one fire detection sensor, and if necessary, set up to output at least one control signal (T1; T2) for the fire detection sensor(s) (12, 13); characterized in that the sensor group (10) also has a chemosensor (11) or a chemosensor array, which is likewise connected to the control and evaluation unit (9) to evaluate the detection signal (S1) of the chemosensor or chemosensor array, and which is set up on the basis of a chemical sensor-operation principle to detect gas and/or smoke emissions created by fire.

2. The fire detector as recited in claim 1, characterized in that the sensor group (10) has a single conventional sensor (12; 13), which is a scattered-light sensor, an ionization sensor, or a temperature sensor.

3. The fire detector as recited in claim 1, characterized in that the sensor group (10) has two conventional sensors.

4. The fire detector as recited in claim 3, characterized in that the two conventional sensors (12 and 13) are a scattered-light sensor or ionization sensor, and a temperature sensor.

5. The fire detector as recited in one of the claims 1 through 4, characterized in that the chemosensor (11) is an optoelectronic gas sensor functioning on an optode basis, or an optoelectronic gas sensor array functioning on an optode basis.

6. The fire detector as recited in one of the preceding claims, characterized in that the control and evaluation unit (9) has a microprocessor and an analog-digital converter for converting the detection signals (S1-S3) supplied by the sensors (11-13) into corresponding digital signals.

7. The fire detector as recited in claim 6, characterized in that the control and evaluation unit (9) is also connected via a bus interface (8) to a bus system (2), through which the fire detector (1) communicates with a primary (master) system.
